(19) United States
(12) Patent Application Publication
(10) Pub. No.: US 2012/0187889 A1
(43) Pub. Date: Jul. 26, 2012

(54) Method and Device for Generating a Variable Motion Profile for a Drive Unit of a Machine

(75) Inventors: Sebastian Krauskopf, Gemuenden-Schalppach (DE); Bartosz Korajda, Lohr-Sendelbach (DE); Oliver Stickel, Lohr Am Main (DE)

(73) Assignee: Robert Bosch GmbH, Stuttgart (DE)

(21) Appl. No.: 13/375,454

(22) PCT Filed: May 27, 2010
(86) PCT No.: PCT/EP2010/003214

§ 371 Date: Apr. 10, 2012

(30) Foreign Application Priority Data
Jun. 2, 2009 (DE) 10 2009 023 475.6

(51) Int. Cl. B25J 9/18

(52) U.S. Cl. 318/568.1

(57) ABSTRACT

The disclosure relates to a method for generating a variable motion profile for a drive unit of a machine, comprising predetermining a plurality of boundary conditions in order to define the variable motion profile, wherein at least one of the boundary conditions is defined using at least one variable or formula relationship. The method further comprises graphically displaying a motion profile based on the plurality of boundary conditions, and mapping the plurality of boundary conditions to a program code, wherein the program code comprises at least one placeholder associated with the variables or the resolved system of equations of the formula relationship.

The present invention relates to a method for generating a variable motion profile for a drive unit in a machine and also to an appropriate apparatus.

Machines for processing or handling products have machine programming which is used to actuate the machine such that it performs a predetermined movement. In this case, an appropriate path of movement is stipulated permanently for a setup or a movement problem. The requisite program code for the machine programming is written manually.

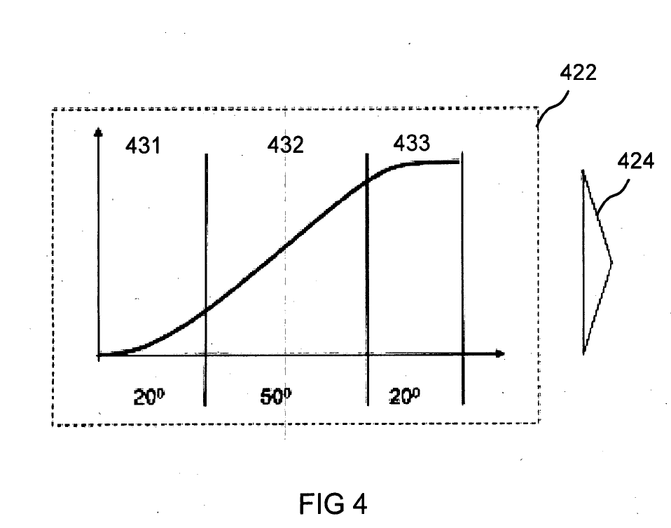

FIG. 4 shows a graphical presentation relating to the implementation of a rigid motion profile 422 by manual code customization 424, in accordance with the prior art. The motion profile 422 is shown by a graph which has a first step 431, a second step 432 and a third step 433. The first step 431 defines a 20° movement, the second step 432 defines a 50° movement and the third step 433 defines a 20° movement for a drive unit in a machine. On the basis of the motion profile 422, the manual code customization 424 can be performed.

This approach results in increased development complexity, which arises from the manual program code writing and customization. In addition, a rigid path of movement means that there is little flexibility.

It is the object of the present invention to provide a method for generating a variable motion profile for a drive unit in a machine and also an appropriate apparatus.

This object is achieved by a method according to claim 1 and an apparatus according to claim 14.

The present invention is based on the insight that the path of movement of a machine can be defined variably. In particular, a movement problem can be defined by means of constraints, variables and formula dependencies. A variable definition of this kind can actually be provided at an early stage of development, before the program code is actually written. In particular, prior to the actual writing of the program code, graphical simulations and visualizations can be performed which can be used to check the chosen variable definition and to graphically present it immediately. The invention therefore also provides a method for generating product-specific, variable movement progressions. The variable definition can be effected by means of an appropriate development program.

The invention provides an engineering solution for movement problems in which the path of movement changes very often. It is therefore possible to provide flexible machines which are customized to a rising product diversity. In addition, the development process can be distinctly simplified, speeded up and hence distinctly shortened. In particular, movement problems can be transferred to motion profiles more easily, more quickly and more efficiently.

The functionality according to the invention allows the implementation of optimum and above all flexible movement guidance and movement control, for example for packing machines, printing machines, textile machines and automation installations.

Advantageously, the approach according to the invention can be integrated into a general and existing engineering process and also into existing tools. In this context, it is possible to produce faster development times and simplified engineering. In particular, it is possible to dispense with manually writing the necessary program code, since the program code can be generated automatically. In addition, visual simulation in advance allows better and faster analysis of the movement problem. Furthermore, definition of symbolic instead of rigid correlations allows more flexible machine programming.

The present invention provides a method for generating a variable motion profile for a drive unit in a machine, which method comprises the following steps: a plurality of constraints are predetermined in order to define the variable motion profile, wherein at least one of the constraints is defined using at least one variable and/or a formula relationship; a motion profile based on the plurality of constraints is graphically presented; and the plurality of constraints are mapped onto a program code, wherein the program code comprises at least one wildcard, associated with the variable, and/or a resolved equation system for the formula relationship, and wherein the program code is suitable for actuating the drive unit in accordance with the variable motion profile.

The machine may be an apparatus which is used in connection with packing, printing, textile or automation installations. The machine may be designed to transport, move or handle a product, a commodity or an article in general. The drive unit may comprise an electrically, hydraulically or pneumatically driven motor. The drive unit may be designed to perform a rotary movement or a linear movement. The drive unit can be actuated by a drive controller which is designed to execute a program code. The variable motion profile can define a time-based movement progression which corresponds to a movement that is to be performed by the drive unit. In this context, variable may mean that a basic pattern for the movement progression has been predefined, but that individual movements can be customized to current problems variably. As a result, it is possible for times, speeds or the scope of individual movements, for example, to be customized at program runtime. The variable motion profile may therefore comprise a plurality of different specific motion profiles which can be customized to a respective situation. In this case, a constraint may define a particular movement which can be performed by the drive unit. By way of example, the plurality of constraints can be input via a man/machine interface into an apparatus for determining the plurality of constraints. The variable may be a fluctuating variable, and the formula relationship may be an arbitrary formula relationship. The formula relationship can refer to another constraint, this constraint itself again possibly having been defined by the indication of symbolic quantities, correlations and formula relationships. Arbitrary recursion is possible provided that no circular reference is obtained. The graphical presentation can be effected by means of a suitable graphical interface. In this case, the motion profile can be displayed in the form of a graph, for example. For the variable, it is then possible to use a predetermined or generated value. The plurality of constraints can be mapped onto the program code using a suitable algorithm. The program code may have a plurality of commands which can be executed by the drive controller, for example. Execution of the program code allows the drive unit to be actuated such that it implements a current motion profile which is dependent on a current value which is used for the variable. In this case, the resolved equation system may likewise be presented in the form of program commands.

In this case, the program code may be designed, when executed, to replace the at least one wildcard with a current parameter and/or to calculate a result for the resolved equation system of the formula relationship. In this way, it is possible to generate a current motion profile for the drive unit. Hence, progressive and flexible customization of the movement progression to be executed by the machine is possible.

In this case, the current parameter may represent a sensor value, a formulation value, a workpiece property, a process quantity, a correction value or an arbitrarily adjustable parameter. In this way, the variable can be set to a current value automatically or by a user input.

In accordance with one embodiment, the at least one variable can be assigned different values. The step of graphical presentation can involve different motion profiles being presented which are associated with the different values. In this way, the variables used can be altered and corresponding effects on the motion profile can be simulated and visualized.

In addition, the step of graphical presentation can involve at least one of the plurality of constraints being altered in order to predetermine an altered plurality of constraints. The altered plurality of constraints can be mapped onto the program code. Hence, by way of example, it is possible to correct an erroneous constraint which has become apparent during the graphical presentation.

By way of example, the drive unit may be part of a packing machine, a printing machine, a textile machine, a press, a reshaping machine, a production machine or another automation installation. The approach according to the invention can therefore be used advantageously for such applications.

The at least one variable or formula relationship may have an associated variable product property, workpiece property and/or process quantity of a product, workpiece and/or process that is to be handled by the machine. By way of example, the at least one variable may be associated with a product length, a product diameter, a printing mark sensor value, a distance between two successive products, or a formula relationship or a combination of a plurality of product properties. It is therefore possible to react to a rising product diversity and to increase the flexibility of the machines.

The plurality of constraints may define angular movements and/or linear movements for an electric, hydraulic and/or pneumatic drive unit. Hence, possible movements which are executed by the drive unit can be predefined by the constraints.

In this case, the plurality of constraints may define a linear or nonlinear motion profile for the drive unit. Hence, it is also possible for complex movement progressions to be predetermined. In particular, the plurality of constraints can define a cam disk for the drive unit. In this context, the cam disk may define a time-based sequence of angular movements which are executed by the drive unit. In this case, angular speeds and angular accelerations may also be defined.

The formula relationship can refer to another of the plurality of constraints. In this case, the other of the plurality of constraints can itself again be defined by indication of symbolic quantities, correlations and formula relationships. Recursions can therefore be inserted.

In accordance with one embodiment, the step of predetermination may involve a plurality of first constraints being predetermined in order to define a first variable motion profile for a first drive unit, and a plurality of further constraints being predetermined in order to define a further variable motion profile for a further drive unit. In this case, at least one of the first constraints can be defined using at least one first variable and/or a first formula relationship, and at least one of the further constraints can be defined using at least one further variable and/or a further formula relationship. The step of graphical presentation may involve a motion profile based on the plurality of first constraints and on the plurality of further constraints being presented. The step of mapping may involve the plurality of first constraints and the plurality of further constraints being mapped onto the program code, wherein the program code comprises at least one wildcard, associated with the first variable, and/or a resolved equation system for the first formula relationship and at least one wildcard, associated with the further variable, and/or a resolved equation system for the further formula relationship, and wherein the program code is suitable for actuating the first drive unit in accordance with the first variable motion profile and for actuating the further drive unit in accordance with the further variable motion profile. The approach according to the solution is therefore also suitable for machines which have a plurality of drive units which interact.

The present invention also provides an apparatus for generating a variable motion profile for a drive unit in a machine, having the following features: a device for predetermining a plurality of individual movements in order to define the variable motion profile, wherein at least one of the individual movements is defined using at least one variable and/or a formula relationship; a device for presenting a motion profile, based on the plurality of individual movements, on a graphical interface; and a device for mapping the plurality of individual movements onto a program code, wherein the program code comprises at least one wildcard, associated with the variable, and/or a resolved equation system for the formula relationship, and wherein the program code is suitable for actuating the drive unit in accordance with the variable motion profile. The apparatus may be produced in hardware and/or in software.

A further advantage is a computer program product having program code which is stored on a machine-readable storage medium such as a semiconductor memory, a hard disk memory or an optical memory and is used for carrying out the method according to one of the embodiments described above when the program is executed on a control unit.

The invention is explained in more detail below by way of example with reference to the appended drawings, in which:

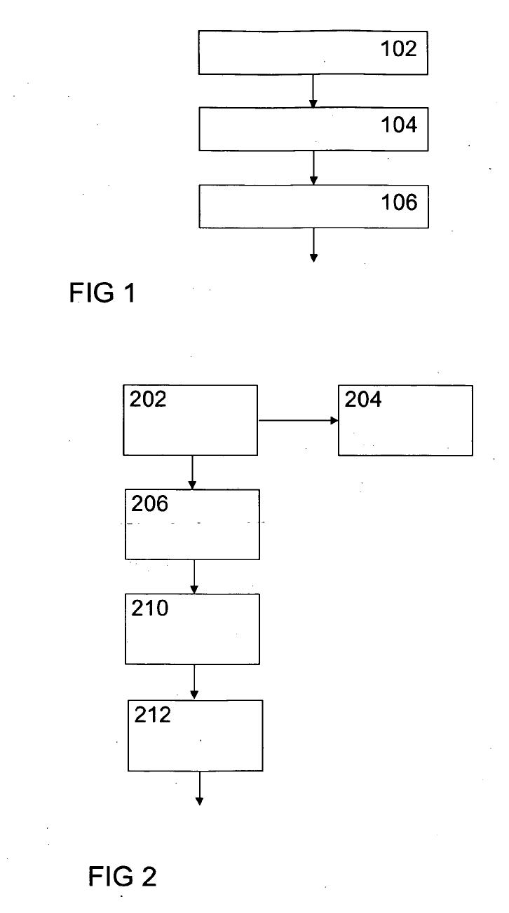

FIG. 1 shows a flowchart for the method according to the invention, based on an exemplary embodiment of the invention;

FIG. 2 shows a block diagram for an apparatus according to the invention, based on an exemplary embodiment of the invention;

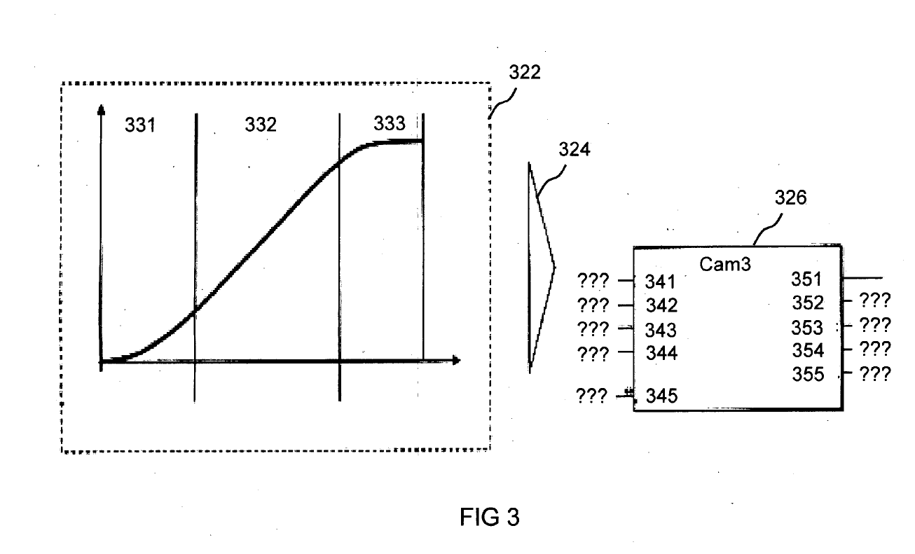

FIG. 3 shows a graphical illustration for the implementation of a flexible motion profile, based on an exemplary embodiment of the invention; and

FIG. 4 shows a graphical illustration for the implementation of a rigid motion profile, based on the prior art.

Elements which are the same or similar may have been provided with reference symbols which are the same or similar in the figures which follow. In addition, the figures of the drawings, the description thereof and the claims contain numerous features in combination. In this context, it is clear to a person skilled in the art that these features can also be considered individually or can be combined to form further combinations, which are not described explicitly here.

FIG. 1 shows a flowchart for a method for generating a variable motion profile for a drive unit in a machine, based on an exemplary embodiment of the present invention.

In a step of predetermination 102, a plurality of constraints can be determined. The constraints may define a variable motion profile. The variable motion profile may comprise a series of specific motion profiles or movement progression which are intended to be executed by the machine. The constraints can be determined on the basis of an analysis of a movement problem which needs to be solved by the machine. In this case, it is possible to take account of machine characteristics and also characteristics of different articles which are intended to be moved or machined by the machine. In order to be able to combine the different, specific motion profiles under the variable motion profile, to define the constraints by using variables or formula relationships. The more parameters are not yet able to be firmly defined at the time by which the constraints are predetermined, the more variables can be used.

In essence, this means that the path of movement and the constraints thereof are defined not quantitatively but rather qualitatively in the form of an equation system. That is to say that the properties of a path of movement are not specified directly but rather are obtained from at least one stipulated mathematical relationship. This relationship may be defined in the form of variables, formulae or the reference to other properties of the path of movement.

In a step of graphical presentation 104, a motion profile can be displayed which is created from the plurality of constraints. The motion profile can be displayed such that it is visible to a developer. In order to be able to display the motion profile, suitable values can be used for the variables, and the formula relationships can be resolved. The motion profile presented may thus be a specific motion profile which is covered by the set of different motion profiles that is defined by the variable motion profile. The values used for the variables may be predetermined or can be defined by the developer. In particular, it is possible to use respective different values for a variable and to present different motion profiles resulting therefrom. By way of example, the developer is able to customize one or more variables following inspection of a motion profile and is then able to have a customized motion profile presented which results therefrom. In this way, it is possible to graphically present all relevant motion profiles which are covered by the variable motion profile.

In a step of mapping 106, the plurality of constraints can be mapped onto a program code. This can be done automatically using a predetermined mapping specification. In order to integrate the variables into the program code, wildcards can be integrated into the program code. In this case, any wildcard may be associated with one of the variables. The formula relationship prescribed in the first step is likewise implemented in program code. The method involves analyzing the formulae and variable relationships for mutual dependencies. In this context, the equation system is resolved inter alia by sorting the formulae and variable relationships according to their dependencies. The program code may be available in the form of a piece of software which, by way of example, can be executed by a control unit in order to actuate the drive unit such that the machine executes movements which correspond to the motion profile defined by the constraints.

In response to the graphical presentation, it is also possible for one or more constraints to be changed. This can be done in the step of graphical presentation 104, the motion profile being able to be presented afresh when the constraints have been changed. Alternatively, on the basis of the graphical presentation 104, it is also possible to perform a fresh step of predetermination 102, which may be followed by a fresh step of graphical presentation 104.

In a further step, the program code can be executed. At the start of or during the execution, the wildcards can be replaced by current values. Hence, current values can be integrated into the program code. The current values can be prescribed as parameters, for example by the developer or by a user. In addition or as an alternative, current values can be captured automatically. In this case, the current values can be provided by sensors, for example. By way of example, the sensors may be optical sensors or tactile sensors, which are able to capture and provide information about bodies that are to be handled. The program code may be designed to perform a check on the current values independently in order to replace the relevant wildcards.

The method according to the invention therefore comprises two core ideas. Firstly, motion profiles are defined, in accordance with the invention, not rigidly by the indication of fixed quantities, e.g. 120 mm, but rather by the indication of symbolic quantities, correlations and formula relationships, e.g. product length*0.5/product diameter. The formula relationships can refer to other motion profile properties. These motion profile properties may themselves again be defined by the indication of symbolic quantities, correlations and formula relationships. Arbitrary recursion is possible provided that no circular reference is obtained. Immediately during the engineering process, it is possible to present a graphical result for the path of movement. In this case, it is possible for the variables used, in this case, by way of example: the product length, etc. . . . , to be altered and for the effect on the resulting path of movement to be simulated and visualized in real time.

In a second step, the necessary program code is then produced automatically from the stipulated correlations, said program code later being loaded onto the executing machine controller. At runtime, the latter then takes the provided process data, which are provided by sensors or parameterization, and uses the previously stipulated correlations to produce the necessary motion profiles.

FIG. 2 shows a schematic illustration of an apparatus for generating a variable motion profile, based on an exemplary embodiment for the present invention. The apparatus has a device 202 for predetermining a plurality of individual movements, a device 204 for presenting a motion profile on a graphical interface and a device 206 for mapping the plurality of individual movements onto a program code. The apparatus may be designed to carry out the method according to the invention for generating a variable motion profile. In this case, the apparatus or individual units of the apparatus may be produced on a control unit, for example in software. The apparatus can also be provided in the form of a development tool.

The program code can be provided for a control device 210 via an appropriate interface. The control device 210 may be designed to execute the program code. In response to execution of the program code, the control device 210 may be designed to actuate a drive unit 212 in the machine such that the drive unit 212 executes movements as are defined by the motion profile.

The device 202 may have an interface which is suitable for allowing a developer to input the constraints. By way of example, the constraints can define the time in which and/or the instant at which the drive unit 212 executes a rotary movement at a particular angle or a linear movement of a particular length and direction. In addition, the constraints may define a speed and/or an acceleration at which a movement is intended to be performed. If the drive unit 212 is designed to execute a rotary movement, the constraints can be used to define a cam disk. The cam disk may define a nonlinear movement progression for the drive unit 212. The device 202 may have an interface which can be used to output control signals to a graphical interface, for example in the form of a display. In response to the control signals, the graphical interface can be used to display a motion profile which is defined by the constraints and appropriate variable values. The device 202 or the device 204 may also have an interface which allows the variables to be assigned different values.

FIG. 3 shows a graphical presentation for the implementation of a flexible motion profile 322 by automatic code generation 324 in a program code 326, based on an exemplary embodiment of the present invention.

The motion profile 322 is shown by a graph which has a first step 331, a second step 332 and a third step 333. Each step 331, 332, 333 may define a movement or a movement section, which represents part of the motion profile 322. The steps 331, 332, 333 can—in accordance with the invention—be predetermined as constraints. On the basis of this exemplary embodiment, the movements in steps 331, 332, 333 are not firmly defined but rather have variables or formula relationships. The first step 331 may define a movement which comprises a product distance as a variable. On the basis of this exemplary embodiment, the first step 331 defines a movement which corresponds to half a product distance (product distance/2). The product distance may be a physical distance between two successive products which are handled by the machine. The second step 332 may define a movement which comprises a product length as a variable. On the basis of this exemplary embodiment, the second step 332 defines a movement which corresponds to ten times the product length (product length*10). The product length may be a physical extent of the product which is handled by the machine. The third step 333 may define a movement which has values as a variable, as are obtained from the first step 331 and the second step 332. On the basis of this exemplary embodiment, the third step 333 defines a movement which corresponds to 360 minus the first step and minus the second step (360−step 1−step 2). Steps 331, 332, 333 are cited merely by way of example. Alternatively, the motion profile 322 may also have more than, fewer than or different steps than those described. It is also possible for individual instances of the steps to be defined not by variables or formula relationships but rather to be firmly defined.

The motion profile 322 can be graphically presented when the constraints have been predetermined, for example in the form shown on a graphical interface.

The automatic code generation 324 can be used to generate the command code shown as command code block Cam3 326. In this case, the equation system provided by variables and formulae is converted into a sequence of machine-executable command code sequence. The input side of the command code block 326 has the inputs “execute” 341, “SetNumber” 342, “Product Length” 342, “Product Distance” 344 and “Axis” 345. The output side of the command code block 326 has the outputs “Done” 351, “Active” 352, “Error” 353, “ErrorID” 354 and “Errorldent” 355.

The exemplary embodiments shown are chosen merely by way of example and can be combined with one another.

Where an exemplary embodiment comprises an “and/or” conjunction between a first feature and a second feature, this can be read as meaning that the exemplary embodiment has both the first feature and the second feature on the basis of one embodiment and has either only the first feature or only the second feature on the basis of a further embodiment.

1. A method for generating a variable motion profile for a drive unit in a machine, comprising:
predetermining a plurality of constraints in order to define the variable motion profile, wherein at least one of the constraints is defined using at least one variable and/or a formula relationship;
graphically presenting a motion profile based on the plurality of constraints; and
mapping the plurality of constraints onto a program code, wherein the program code comprises at least one wildcard, associated with the variable, and/or a resolved equation system for the formula relationship, and wherein the program code is suitable for actuating the drive unit in accordance with the variable motion profile.

2. The method as claimed in claim 1, wherein the program code is designed, when executed, to replace the at least one wildcard with a current parameter and/or to calculate a result for the resolved equation system of the formula relationship in order to generate a current motion profile for the drive unit.

3. The method as claimed in claim 2, wherein the current parameter represents a sensor value, a formulation value, a workpiece property, a process quantity, a correction value or an arbitrarily adjustable parameter.

4. The method as claimed in claim 1, wherein:
the at least one variable is assigned different values, and
the graphically presenting involves different motion profiles being presented which are associated with the different values.

5. The method as claimed in claim 1, wherein:
the graphically presenting involves at least one of the plurality of constraints being altered in order to predetermine an altered plurality of constraints, and
the altered plurality of constraints is mapped onto the program code.

6. The method as claimed in claim 1, wherein the drive unit is part of a packing machine, a printing machine, a textile machine, a press, a reshaping machine, a production machine or another automation installation.

7. The method as claimed in claim 1, wherein the at least one variable or formula relationship is associated with a variable product property, workpiece property and/or process quantity of a product, workpiece and/or process that is to be handled by the machine.

8. The method as claimed in claim 7, wherein the at least one variable is associated with a product length, a product diameter, a printing mark sensor value or a distance between two successive products.

9. The method as claimed in claim 1, wherein the plurality of constraints define angular movements and/or linear movements for an electric, hydraulic and/or pneumatic drive unit.

10. The method as claimed in one of the preceding claims claim 1, wherein the plurality of constraints define a linear or nonlinear motion profile for the drive unit.

11. The method as claimed in claim 1, wherein the plurality of constraints define a cam disk for the drive unit.

12. The method as claimed in claim 1, wherein the formula relationship refers to another of the plurality of constraints, the other of the plurality of constraints itself again possibly having been defined by the indication of symbolic quantities, correlations and formula relationships.

13. The method as claimed in claim 1, wherein:
the predetermining a plurality of constraints involves a plurality of first constraints being predetermined in order to define a first variable motion profile for a first drive unit, and a plurality of further constraints being predetermined in order to define a further variable motion profile for a further drive unit,
at least one of the first constraints is defined using at least one first variable and/or a first formula relationship, and at least one of the further constraints is defined using at least one further variable and/or a further formula relationship,
the graphically presenting involves a motion profile based on the plurality of first constraints and on the plurality of further constraints being presented,
the mapping the plurality of constraints involves the plurality of first constraints and the plurality of further constraints being mapped onto the program code,
the program code comprises at least one wildcard, associated with the first variable, and/or a resolved equation system for the first formula relationship and at least one wildcard, associated with the further variable, and/or a resolved equation system for the further formula relationship, and
the program code is suitable for actuating the first drive unit in accordance with the first variable motion profile and for actuating the further drive unit in accordance with the further variable motion profile.

14. An apparatus for generating a variable motion profile for a drive unit in a machine, comprising:
a first device for setting up for the a plurality of individual movements in order to define the variable motion profile, wherein at least one of the individual movements is defined using at least one variable and/or a formula relationship;
a second device for presenting a motion profile, based on the plurality of individual movements, on a graphical interface; and
a third device for mapping the plurality of individual movements onto a program code, wherein the program code comprises at least one wildcard, associated with the variable, and/or a resolved equation system for the formula relationship, and wherein the program code is suitable for actuating the drive unit in accordance with the variable motion profile.

15. A computer program product having program code, which is stored on a machine-readable storage medium, for carrying out a method when the program is executed on a control unit, the method comprising:
predetermining a plurality of constraints in order to define the variable motion profile, wherein at least one of the constraints is defined using at least one variable and/or a formula relationship;
graphically presenting a motion profile based on the plurality of constraints; and
mapping the plurality of constraints onto a program code, wherein the program code comprises at least one wildcard, associated with the variable, and/or a resolved equation system for the formula relationship, and wherein the program code is suitable for actuating the drive unit in accordance with the variable motion profile.
